(19) United States
(12) Patent Application Publication
(10) Pub. No.: US 2026/0302535 A1
(43) Pub. Date: Oct. 1, 2026

(54) INSULATING MEMBER FOR SECONDARY BATTERY AND SECONDARY BATTERY INCLUDING THE INSULATING MEMBER

(71) Applicant: SAMSUNG SDI CO., LTD., Yongin-si (KR)

(72) Inventor: Junho BYEON, Yongin-si (KR)

(21) Appl. No.: 19/561,750

(22) Filed: Mar. 10, 2026

(30) Foreign Application Priority Data
Mar. 28, 2025 (KR) 10-2025-0040314

(51) Int. Cl. H01M 50/474; H01M 10/052; H01M 50/103; H01M 50/477; H01M 50/503; H01M 50/627

(52) U.S. Cl. CPC H01M 50/474; H01M 10/052; H01M 50/103; H01M 50/477; H01M 50/503; H01M 50/627

(57) ABSTRACT

The present disclosure relates to an insulating member for a secondary battery and a secondary battery including the same. The insulating member is configured to be disposed in a gap between an electrode assembly and a case configured to accommodate the electrode assembly. The insulating member includes a plate-shaped body portion including an insulating material, a first lead tab at least partially penetrating the body portion and configured to be electrically connected to a first electrode tab of the electrode assembly, and a second lead tab at least partially penetrating the body portion and configured to be electrically connected to a second electrode tab of the electrode assembly.

### CROSS-REFERENCE TO RELATED APPLICATION

The present application claims priority to and the benefit of Korean Application No. 10-2025-0040314, filed on Mar. 28, 2025, in the Korean Intellectual Property Office, the entire disclosure of which is incorporated by reference herein.

### BACKGROUND

### Field

The present disclosure relates to an insulating member for a secondary battery and a secondary battery including the insulating member.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

When a short circuit occurs inside a secondary battery, the electrical resistance inside the battery may decrease rapidly, thereby causing excessive current to flow. Due to this, a thermal runaway may occur, in which the temperature inside the battery rises rapidly. The secondary battery may lead to an explosion or fire as a consequence of the thermal runaway. In addition, the short circuit may rapidly lower the internal resistance, thereby shortening the life of the battery and causing a rapid deterioration in performance. Therefore, it is desirable to prevent a short circuit without affecting the energy density of the secondary battery.

The above information disclosed in this Background section is for enhancement of understanding of the background of the present disclosure, and therefore, it may contain information that does not constitute related (or prior) art.

### SUMMARY

The present disclosure provides an insulating member for a secondary battery and a secondary battery including the insulating member for solving the above technical problem.

These and other aspects and features of the present disclosure will be described in or will be apparent from the following description of embodiments of the present disclosure.

Disclosed herein are embodiments of an insulating member for a secondary battery, provided for solving the technical problem. The insulating member is configured to be disposed in a gap between an electrode assembly and a case in which the electrode assembly is accommodated. The insulating member includes a plate-shaped body portion including an insulating material, a first lead tab at least partially penetrating the body portion and configured to be electrically connected to a first electrode tab of the electrode assembly, and a second lead tab at least partially penetrating the body portion and configured to be electrically connected to a second electrode tab of the electrode assembly.

According to some embodiments of the present disclosure for solving the technical problem, a secondary battery includes a case, an electrode assembly accommodated in the case, and an insulating member disposed in a gap between the electrode assembly and the case, wherein the insulating member includes a plate-shaped body portion including an insulating material, a first lead tab at least partially penetrating the body portion and configured to be electrically connected to a first electrode tab of the electrode assembly, and a second lead tab at least partially penetrating the body portion and configured to be electrically connected to a second electrode tab of the electrode assembly.

An insulating member according to embodiments of the present disclosure may simultaneously perform the role of a terminal that electrically connects an electrode tab of an electrode assembly with an external device and the role of an insulating member that prevents a short circuit inside a secondary battery. Additionally, there is no need to assemble a positive electrode terminal, a negative electrode terminal, etc. to a case, so the time and cost required for the manufacturing process of a secondary battery may be reduced. Further, instead of a positive electrode terminal, a negative electrode terminal, and an insulating object for preventing a short circuit inside a secondary battery, an insulating member according to the embodiments of the present disclosure may be used, so the volume of the secondary battery may be reduced. Accordingly, the energy density of the secondary battery may be increased.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view of a secondary battery according to some embodiments of the present disclosure.

FIG. 2 illustrates a secondary battery according to some embodiments of the present disclosure.

FIG. 3 illustrates an electrode assembly and an insulating member according to some embodiments of the present disclosure.

FIG. 4 is a perspective view of an insulating member according to some embodiments of the present disclosure.

FIG. 5 is a plan view of an insulating member according to some embodiments of the present disclosure.

FIG. 6 is a bottom view of an insulating member according to some embodiments of the present disclosure.

FIG. 7 is a cross-sectional view of an insulating member according to some embodiments of the present disclosure.

FIG. 8 is a cross-sectional view of an insulating member according to some embodiments of the present disclosure.

FIG. 9 is a perspective view of an insulating member according to some embodiments of the present disclosure.

FIG. 10 is a plan view of a first lead tab, an insulating portion, and a first coupling portion according to some embodiments of the present disclosure.

FIG. 11 is a plan view of a second lead tab and a second coupling portion according to some embodiments of the present disclosure.

FIG. 12 is a cross-sectional view of an insulating member according to some embodiments of the present disclosure.

FIG. 13 is a cross-sectional view of an insulating member according to some embodiments of the present disclosure.

FIG. 14 is a perspective view of a secondary battery according to some embodiments of the present disclosure.

FIG. 15 is a cross-sectional view of a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes and relative sizes of layers and regions shown in the drawings may be exaggerated for clarity of description. That is, the sizes shown in the drawings are for convenience of understanding and are not limited thereto. In addition, the same reference numerals refer to the same components throughout the specification.

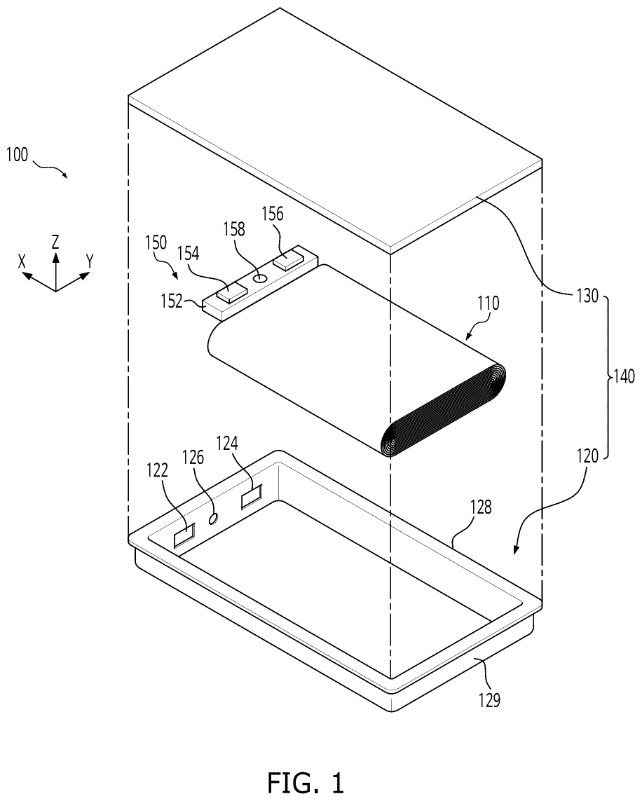

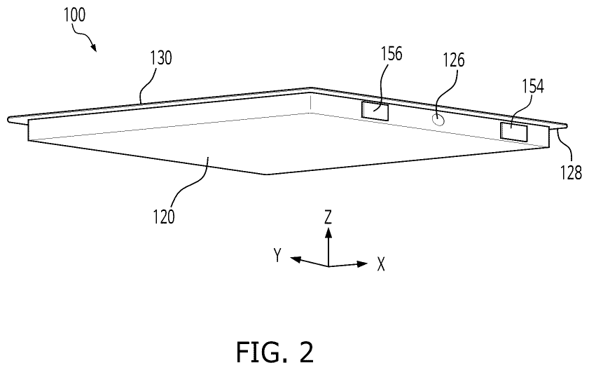

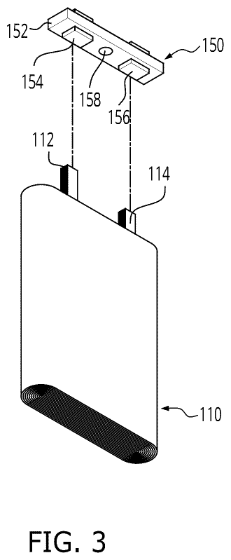

FIG. 1 is an exploded perspective view illustrating an example of a secondary battery 100 according to some embodiments of the present disclosure. FIG. 2 illustrates an example of the secondary battery 100 according to some embodiments of the present disclosure. FIG. 3 illustrates an example of an electrode assembly 110 and an insulating member 150 according to some embodiments of the present disclosure.

Referring to FIGS. 1-3, a secondary battery 100 may include an electrode assembly 110 including a positive electrode, a separator, and a negative electrode. The secondary battery 100 may further include a case 140 that accommodates the electrode assembly 110. Here, the case 140 may include a case body 120 that accommodates the electrode assembly 110 and has an opening in open surface (such as, for example, one surface of the case body 120 in a Z-axis direction). The case 140 may further include a cover 130 that is seated on a surface of the case body 120 to close the opening and is coupled with the case body 120. The electrode assembly 110 may be wound or stacked with a separator, which is an insulator, interposed between the positive electrode and the negative electrode.

The case 140 may include stainless steel (SUS), such that in one example, the secondary battery 100 may be a SUS can type secondary battery. The case 140 of the SUS can type secondary battery may have a thickness of about 0.1 mm and provide sufficient stability due to the characteristics of SUS. A thickness of the case 140 may be, for example, 0.01-0.2 mm. However, the thickness of the case 140 is not limited thereto. In one embodiment, the case 140 may be formed of a conductive metal such as aluminum, an aluminum alloy, or nickel-plated steel, which resultantly forms the overall exterior of the secondary battery 100.

A first electrode tab 112 may be connected to one side of a first electrode (e.g., a positive electrode) of the electrode assembly 110, and a second electrode tab 114 may be connected to one side of a second electrode (e.g., a negative electrode). The first electrode tab 112 and the second electrode tab 114 may be connected by welding a base material tab to an uncoated portion of the first electrode and the second electrode, or may be formed by punching out the uncoated portion of the first electrode and the second electrode. In a wound state, the first electrode tab 112 and the second electrode tab 114 may be disposed parallel to each other at a constant interval. However, the first electrode tab 112 and the second electrode tab 114 may be disposed on different sides of the electrode assembly 110. That is, the electrode assembly 110 may have any structure including electrode tabs. The first electrode tab 112 may be a positive electrode tab, and the second electrode tab 114 may be a negative electrode tab. However, the present disclosure is not limited thereto, and the first electrode tab 112 may a negative electrode tab and the second electrode tab 114 may be a positive electrode tab.

An insulating member 150 may be disposed in a gap between the electrode assembly 110 and the case 140. For example, the insulating member 150 may be disposed between one surface of a receiving portion 129 included in the case 140 (such as, for example, one surface of the case 140 on which a first lead tab hole 122 and/or a second lead tab hole 124 are formed) and the electrode assembly 110. In addition, the insulating member 150 may be disposed on the first electrode tab 112 and the second electrode tab 114 of the electrode assembly 110.

The insulating member 150 may include a plate-shaped body portion 152 including an insulating material. The insulating material may include, for example, polypropylene (PP), polyethylene (PE), polyimide (PI), polyethylene terephthalate (PET), or the like. The plate-shaped body portion 152 may cover at least a portion of one surface of the case 140. In addition, the body portion 152 may cover at least a portion of one side of the electrode assembly 110. Since the body portion 152 has a plate shape, the body portion 152 may be disposed in a minimum amount of space between the electrode assembly 110 and the case 140. Consequently, a process for manufacturing the insulating member 150 may also be simplified.

The insulating member 150 may include a first lead tab 154 at least partially penetrating the body portion 152 and a second lead tab 156 at least partially penetrating the body portion 152. The first lead tab 154 may be electrically connected to the first electrode tab 112 of the electrode assembly 110. The second lead tab 156 may be electrically connected to the second electrode tab 114 of the electrode assembly 110. Referring to FIG. 3, the first electrode tab 112 may be electrically connected by being coupled with the first lead tab 154 by welding, press-fitting, or the like. Similarly, the second electrode tab 114 may be electrically connected by being coupled with the second lead tab 156 by welding, press-fitting, or the like. At this time, the first electrode tab 112 and the second electrode tab 114 may be bent between the insulating member 150 and the electrode assembly 110.

The insulating member 150 may include an electrolyte passage 158 that is formed to penetrate the body portion 152. The electrolyte passage 158 may be configured to allow for the supply of an electrolyte to the electrode assembly 110. For example, the electrolyte supplied through an electrolyte injection port 126 of the case 140 may be supplied to the electrode assembly 110 along the electrolyte passage 158.

In some embodiments, a case body 120 may include a first lead tab hole 122 penetrating one surface of the case (such as, for example, one surface of the case body 120 in an X-axis direction) and a second lead tab hole 124 penetrating the one surface of the case. The first lead tab 154 of the insulating member 150 may be inserted into the first lead tab hole 122, and the second lead tab 156 may be inserted into the second lead tab hole 124. In this configuration, at least a portion of the first lead tab 154 may penetrate the case 140 and protrude from one surface of the case 140. In addition, at least a portion of the second lead tab 156 may penetrate the case 140 and protrude from the one surface of the case 140. The first lead tab 154 protruding through the first lead tab hole 122 may be electrically connected to an external terminal. In addition, the second lead tab 156 protruding through the second lead tab hole 124 may be electrically connected to an external terminal. A shape of the first lead tab hole 122 may correspond to a shape of the first lead tab 154, and a shape of the second lead tab hole 124 may correspond to a shape of the second lead tab 156. The positions of the first lead tab hole 122 and the second lead tab hole 124 are not limited to the positions illustrated in FIG. 1 and FIG. 2, and the positions may be varied.

The case body 120 may include an electrolyte injection port 126. For example, the electrolyte injection port 126 may be a through-hole formed on one surface of the case body 120 (such as, for example, one surface of the case body 120 in an X-axis direction) and may be formed to allow the injection of an electrolyte into the case of the secondary battery 100 after the case body 120 and a cover 130 are joined and sealed. Although the electrolyte injection port 126 is illustrated as being located between the first lead tab hole 122 and the second lead tab hole 124, the present disclosure is not limited thereto and may have various other arrangement.

The electrolyte injection port 126 may face an electrolyte passage 158. In an example configuration, an electrolyte supply device (e.g., a needle, etc.) may be inserted through the electrolyte injection port 126. The electrolyte supply device may be simultaneously inserted into the electrolyte passage 158 and configured to supply an electrolyte into the case 140. Alternatively, the electrolyte supplied by the electrolyte supply device may flow along the electrolyte passage 158 and be supplied to the electrode assembly 110.

The case body 120 may include a receiving portion 129 and a flange 128. Specifically, a receiving portion 129 in which an electrode assembly 110 is accommodated may be formed in a substantially central region of the case body 120 by press processing or the like. In addition, a flange 128 extending outward from an upper end of the receiving portion 129 may be formed. For example, the flange 128 may extend in four directions on an upper edge of the receiving portion 129.

A case body 120 and a cover 130 may be joined to form an exterior of the secondary battery 100. For example, the case body 120 and the cover 130 may be metal-bonded (e.g., welded, brazed, soldered, etc.). In this case, a flange 128 of the case body 120 and an edge of the cover 130 may be joined. In addition, after the case body 120 and the cover 130 are joined, at least a portion of the flange 128 may be cut using a laser to improve the energy density of the secondary battery 100.

Although a case with a flange is illustrated herein, the present disclosure is not limited thereto. A case body may be joined with a cover 130 without a flange.

The secondary battery 100 may be a lithium battery cell, a sodium battery cell, or the like. However, the scope of the present disclosure is not limited with respect to the type of battery, and the secondary battery 100 may include any battery that can repeatedly provide electricity through charging and discharging. In some embodiments, when the secondary battery 100 is a lithium battery cell, the secondary battery 100 may be used in an electric vehicle (EV) because of its excellent cycle life characteristics and high-rate characteristics. For example, the secondary battery 100 may be used in a hybrid vehicle such as a plug-in hybrid electric vehicle (PHEV). In addition, the lithium battery cell may be used in fields that require storage of a large amount of electric power. For example, the lithium battery cell may be used in an electric bicycle, a power tool, or the like.

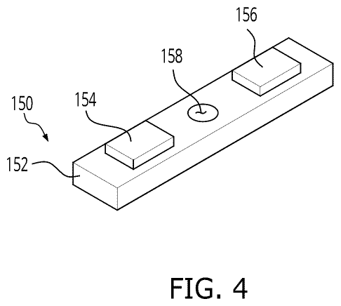

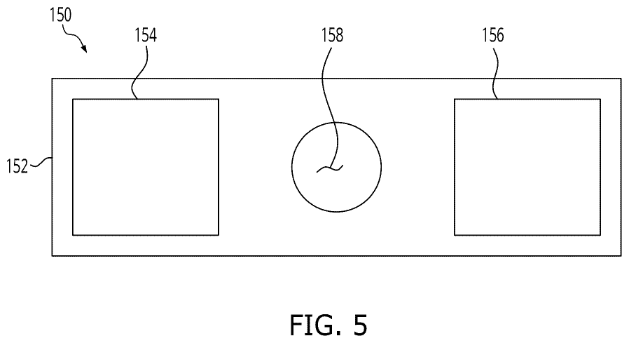

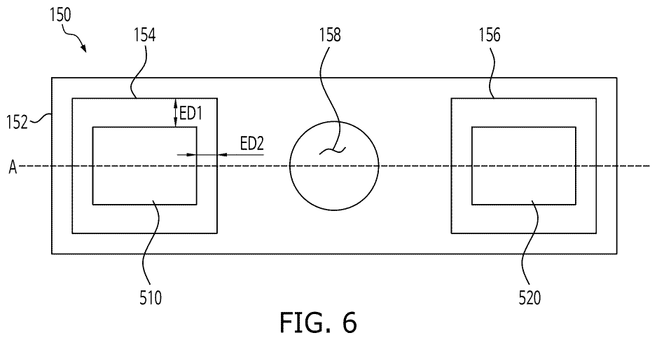

FIG. 4 is a perspective view of an insulating member 150 according to some embodiments of the present disclosure. FIG. 5 is a plan view of the insulating member 150 according to some embodiments of the present disclosure. FIG. 6 is a bottom view of the insulating member 150 according to some embodiments of the present disclosure.

Referring to FIG. 4, an insulating member 150 may include a plate-shaped body portion 152 including an insulating material, a first lead tab 154 at least partially penetrating the body portion 152, and a second lead tab 156 at least partially penetrating the body portion 152. The first lead tab 154 may be configured to be electrically connected to a first electrode tab of an electrode assembly. The second lead tab 156 may be configured to be electrically connected to a second electrode tab of the electrode assembly.

An upper surface of the insulating member 150 may be configured to face a surface of a case, and a lower surface of the insulating member 150 (such as, for example, a surface opposite the upper surface of the insulating member 150) may be configured to face an electrode assembly. The insulating member 150 may include an electrolyte passage 158 formed to penetrate the body portion 152. An electrolyte may be supplied from outside the case to the electrode assembly through the electrolyte passage 158. Here, the upper surface and the lower surface merely indicate top and bottom as shown in the drawings and do not limit the position of the components. The same applies hereinafter.

Although FIG. 4 illustrates an electrolyte passage 158 disposed between the first lead tab 154 and the second lead tab 156, the present disclosure is not limited thereto. The electrolyte passage 158 may be formed at various positions in the body portion 152.

Referring to FIG. 5, an upper surface of an insulating member 150 configured to face one surface of a case is shown. An upper surface of a first lead tab 154 may be exposed to outside of the case through a first lead tab hole of the case. An upper surface of a second lead tab 156 may be exposed to outside of the case through a second lead tab hole of the case. An electrolyte passage 158 may face an electrolyte injection port of the case, thereby forming a single through-hole.

Referring to FIG. 6, a lower surface of an insulating member 150 configured to face an electrode assembly may be shown. A lower surface of a first lead tab 154 (such as, for example, a surface opposite an upper surface of the first lead tab 154) may face the electrode assembly. At least a portion of the lower surface of the first lead tab 154 may be configured to be coupled with a first electrode tab of the electrode assembly. A lower surface of a second lead tab 156 (such as, for example, a surface opposite an upper surface of the second lead tab 154) may face the electrode assembly. At least a portion of the lower surface of the second lead tab 156 may be configured to be coupled with a second electrode tab of the electrode assembly.

In some embodiments, the lower surface of the first lead tab 154 may include a first coupling region 510 configured to be coupled with the first electrode tab of the electrode assembly. The first coupling region 510 may be welded to, press-fitted to, or in contact with the first electrode tab. Similarly, the lower surface of the second lead tab 156 may include a second coupling region 520 configured to be coupled with the second electrode tab of the electrode assembly. The second coupling region 520 may be configured to be welded to, press-fitted to, or in contact with the second electrode tab.

In some embodiments, a periphery of the first coupling region 510 may be spaced apart from an outer periphery of the lower surface of the first lead tab 154 by a predetermined distance. Referring to FIG. 6, the first coupling region 510 may have a polygonal shape, and the lower surface of the first lead tab 154 may have a polygonal shape. A distance ED1 between one edge of the first coupling region 510 and one edge of the lower surface of the first lead tab 154 (such as, for example, an edge facing the one edge of the first coupling region 510). In addition, a distance ED2 between another edge of the first coupling region 510 and another edge of the lower surface of the second lead tab (such as, for example, an edge facing the other edge of the first coupling region 510). Here, the distance may be about 1.5 mm or less. Similarly, a periphery of the second coupling region 520 may be spaced apart from an outer periphery of the lower surface of the second lead tab 156 by a distance.

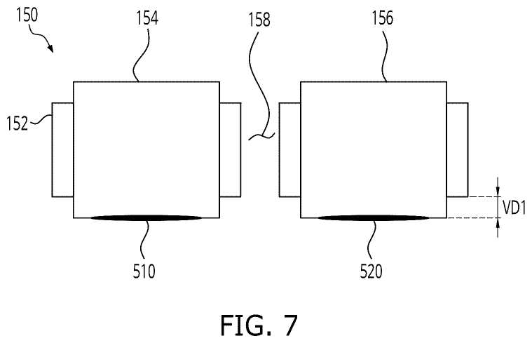

FIG. 7 is a cross-sectional view of an insulating member 150 according to some embodiments of the present disclosure. In FIG. 7, the structure of the insulating member 150 will be described with reference to a cross-sectional view of the insulating member 150 taken approximately along a cutting line A of FIG. 6.

An upper surface of the insulating member 150 may be configured to face one surface of a case, and a lower surface of the insulating member 150 may be configured to face an electrode assembly. In addition, a lower surface of a body portion 152 may be configured to face the electrode assembly. A lower surface of a first lead tab 154 may include a first coupling region 510 configured to be coupled with a first electrode tab of the electrode assembly. A lower surface of a second lead tab 156 may include a second coupling region 520 configured to be coupled with a second electrode tab of the electrode assembly.

The lower surface of the first lead tab 154 may protrude from the lower surface of the body portion 152. In addition, the lower surface of the second lead tab 156 may protrude from the lower surface of the body portion 152. For example, a vertical distance between the lower surface of the first lead tab 154 and the lower surface of the body portion 152 may be about 1 mm or less. In addition, a vertical distance VD1 between the lower surface of the second lead tab and the lower surface of the body portion may be about 1 mm or less. Here, a thickness of the body portion 152 may be greater than or equal to 1 mm.

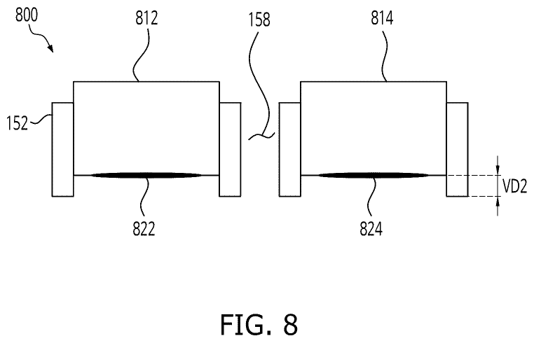

FIG. 8 is a cross-sectional view of an insulating member 800 according to some embodiments of the present disclosure. The insulating member 800 may be substantially the same as the remaining components of the insulating member 150 of FIG. 7, excluding a first lead tab 154 and a second lead tab 156. FIG. 8 will be described focusing on a first lead tab 812 and a second lead tab 814 of the insulating member 800.

The first lead tab 812 and the second lead tab 814 may each be formed to at least partially penetrate into a body portion 152. A lower surface of the first lead tab 812 may include a first coupling region 822 configured to be coupled with a first electrode tab of an electrode assembly, and a lower surface of the second lead tab 814 may include a second coupling region 824 configured to be coupled with a second electrode tab of the electrode assembly.

The lower surface of the first lead tab 812 may be recessed into the body portion 152. The lower surface of the second lead tab 814 may be recessed into the body portion 152. A vertical distance between the lower surface of the first lead tab 812 and a lower surface of the body portion 152 may be about 1 mm or less. In addition, a vertical distance VD2 between the lower surface of the second lead tab and the lower surface of the body portion may be about 1 mm or less. Here, a thickness of the body portion 152 may be greater than or equal to 1 mm.

A first electrode tab of an electrode assembly may be bent under an insulating member 800 to be coupled with a first coupling region 822 or may come into contact with a body portion 152. In addition, a second electrode tab of the electrode assembly may be bent under the insulating member 800 to be coupled with a second coupling region 824 or may come into contact with the insulating member 800. Because the body portion 152 includes an insulating material and covers one side of the electrode assembly, a short circuit caused by the electrode tabs may be prevented.

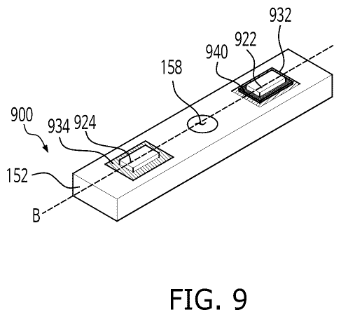

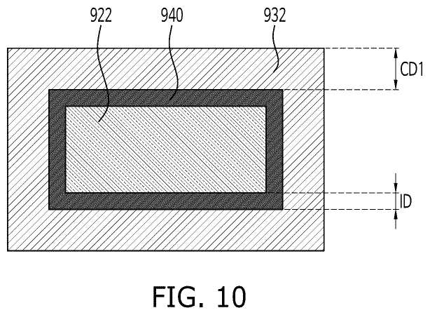

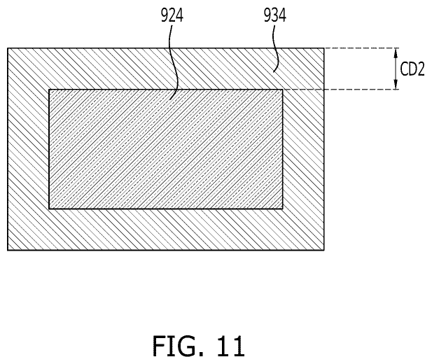

FIG. 9 is a perspective view of an insulating member 900 according to some embodiments of the present disclosure. FIG. 10 is a plan view of a first lead tab 922, an insulating portion 940, and a first coupling portion 932 according to some embodiments of the present disclosure. FIG. 11 is a plan view of a second lead tab 924 and a second coupling portion 934 according to some embodiments of the present disclosure.

Referring to FIG. 9, an insulating member 900 may include a plate-shaped body portion 152 including an insulating material, a first lead tab 922 formed to at least partially penetrate the body portion 152, and a second lead tab 924 formed to at least partially penetrate the body portion 152. The first lead tab 922 may be electrically connected to a first electrode tab (e.g., a positive electrode tab) of an electrode assembly. The second lead tab 924 may be electrically connected to a second electrode tab (e.g., a negative electrode tab) of the electrode assembly.

The insulating member 900 may include an electrolyte passage 158 formed to penetrate a body portion 152. Referring to FIG. 9, the electrolyte passage 158 may be located between a first lead tab 922 and a second lead tab 924. However, the present disclosure is not limited thereto, and the electrolyte passage 158 may be formed at various positions in the body portion 152.

The insulating member 900 may include an insulating portion 940 surrounding at least a portion of a side surface of a first lead tab 922. In addition, the insulating member 900 may include a first coupling portion 932 surrounding at least a portion of a side surface of the insulating portion 940. The first coupling portion 932 may be configured to be coupled with a case. For example, the first coupling portion 932 may be welding to a first sub-region of a first lead tab hole of the case. The first sub-region may be a partial region of one surface of the case that surrounds the first lead tab hole. For this purpose, the first coupling portion 932 may include a metal.

The insulating member 900 may include a second coupling portion 934 surrounding at least a portion of a side surface of a second lead tab 924. The second coupling portion 934 may be configured to be coupled with a case. For example, the second coupling portion 934 may be coupled by welding or the like to a second sub-region of a second lead tab hole of the case. Here, the second sub-region may be a partial region of the case that surrounds the second lead tab hole. For this purpose, the second coupling portion 934 may include a metal. Thus, the second lead tab 924 may be electrically connected to the second coupling portion 934, and the second coupling portion 934 may be electrically connected to the case.

Referring to FIG. 10, an insulating portion 940 may surround at least a portion of a side surface of a first lead tab 922, and a first coupling portion 932 may surround at least a portion of a side surface of the insulating portion 940. That is, the insulating portion 940 may be disposed between the first lead tab 922 and the first coupling portion 932. The insulating portion 940 may electrically insulate between the first lead tab 922, which includes a conductive material, and the first coupling portion 932, which includes a metal or the like.

A distance between an inner periphery and an outer periphery of the insulating portion 940 may be about 0.5 mm or greater. A distance between an inner periphery and an outer periphery of the first coupling portion 320 may be about 1.0 mm or greater. For example, the first lead tab 922 may have a prismatic shape such that one surface and/or a cross-section of the first lead tab 922 may be a polygon. Correspondingly, the inner periphery of the insulating portion 940 may have a polygonal shape. In addition, an outer periphery of the insulating portion 940 may have a polygonal shape, and an outer periphery of the first coupling portion 932 may have a polygonal shape. A distance ID between one edge of the inner periphery of the insulating portion and one edge of the outer periphery of the insulating portion (such as, for example, an edge opposite the one edge of the inner periphery of the insulating portion 940) may be about 0.5 mm or greater. In addition, a distance CD1 between one edge of the inner periphery of the first coupling portion and one edge of the outer periphery of the first coupling portion (such as, for example, an edge opposite the one edge of the inner periphery of the first coupling portion 932) may be about 1.0 mm or greater.

Referring to FIG. 11, a second coupling portion 934 may surround at least a portion of a side surface of a second lead tab 924.

A distance between an inner periphery and an outer periphery of the second coupling portion 934 may be about 1.0 mm or greater. The second lead tab 924 may have a prismatic shape such that one surface and/or a cross-section of the second lead tab 924 may be a polygon. Correspondingly, the inner periphery of the second coupling portion 934 may have a polygonal shape. In addition, an outer periphery of the second coupling portion 934 may have a polygonal shape. A distance CD2 between one edge of the inner periphery of the second coupling portion and one edge of the outer periphery of the second coupling portion (such as, for example, an edge opposite the one edge of the inner periphery of the second coupling portion 934) may be about 1.0 mm or greater.

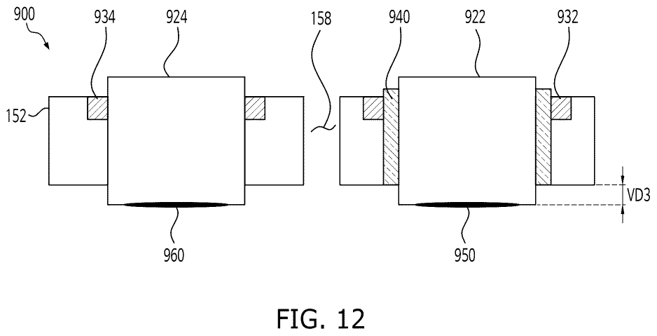

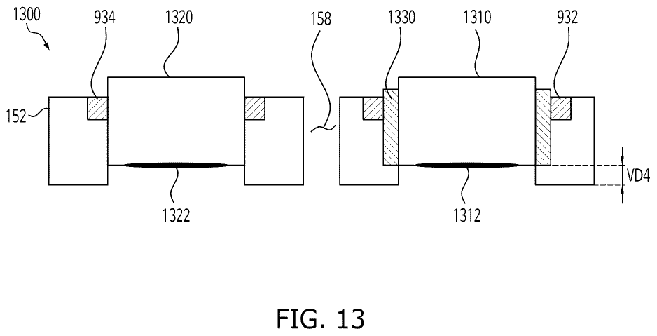

FIG. 12 is a cross-sectional view of an insulating member 900 according to some embodiments of the present disclosure. In FIG. 9, a cut line B that approximately crosses the center of a first lead tab 922, a second lead tab 924, and a body portion 152 is shown. In FIG. 12 and FIG. 13, the structure of the insulating member 900 will be described with reference to a cross-sectional view of the insulating member 900 taken approximately along the cut line B.

An upper surface of the insulating member 900 may be configured to face one surface of a case, and a lower surface of the insulating member 900 may be configured to face an electrode assembly. In addition, a lower surface of a body portion 152 may be configured to face the electrode assembly. A lower surface of a first lead tab 922 may include a first coupling region 950 configured to be coupled with a first electrode tab of the electrode assembly. A lower surface of a second lead tab 924 may include a second coupling region 960 configured to be coupled with a second electrode tab of the electrode assembly.

The lower surface of the first lead tab 922 may protrude from the lower surface of the body portion 152. In addition, the lower surface of the second lead tab 924 may protrude from the lower surface of the body portion 152. A vertical distance between the lower surface of the first lead tab 922 and the lower surface of the body portion 152 may be about 1 mm or less. A vertical distance VD3 between the lower surface of the second lead tab and the lower surface of the body portion may be about 1 mm or less. Here, a thickness of the body portion 152 may be greater than or equal to 1 mm.

A thickness of a first coupling portion 932 may be less than a thickness of a body portion 152. An insulating portion 940 may cover a region of a side surface of a first lead tab 922 that faces the first coupling portion 932. In addition, a thickness of the insulating portion 940 may be greater than the thickness of the first coupling portion 932. As a result, the insulating portion 940 may electrically insulate between the first coupling portion 932 and the first lead tab 922. In addition, a thickness of a second coupling portion 934 may be less than the thickness of the body portion 152.

FIG. 13 is a cross-sectional view of an insulating member 1300 according to some embodiments of the present disclosure. The insulating member 1300 may be substantially the same as the components of the insulating member 900 of FIG. 12, excluding a first lead tab 922, a second lead tab 924, and an insulating portion 940. FIG. 13 will be described with focus on a first lead tab 1300, an insulating portion 1330, and a second lead tab 1320 of the insulating member 1300.

A first lead tab 1310 and a second lead tab 1320 may be formed to at least partially penetrate a body portion 152. A lower surface of the first lead tab 1310 may include a first coupling region 1312 configured to be coupled with a first electrode tab of an electrode assembly. A lower surface of the second lead tab 1320 may include a second coupling region 1322 configured to be coupled with a second electrode tab of the electrode assembly.

The lower surface of the first lead tab 1310 may be recessed into the body portion 152. The lower surface of the second lead tab 1320 may be recessed into the body portion 152. A vertical distance between the lower surface of the first lead tab 1310 and a lower surface of the body portion 152 may be about 1 mm or less. A vertical distance VD4 between the lower surface of the second lead tab and the lower surface of the body portion may be about 1 mm or less. Here, a thickness of the body portion 152 may be greater than or equal to 1 mm. An insulating portion 1330 may surround at least a portion of a side surface of the first lead tab 1310. Corresponding to the recessed first lead tab 1310, a lower surface of the insulating portion 1330 may be located above the lower surface of the first lead tab 1310.

A first electrode tab of an electrode assembly may be bent under an insulating member 1300 to be coupled with a first coupling region 1312, or the first electrode tab may come into contact with a body portion 152. In addition, a second electrode tab of the electrode assembly may be bent under the insulating member 1300 to be coupled with a second coupling region 1322, or the second electrode tab may come into contact with the insulating member 1300. Because the body portion 152 includes an insulating material and covers one side of the electrode assembly, a short circuit caused by the electrode tabs may be prevented.

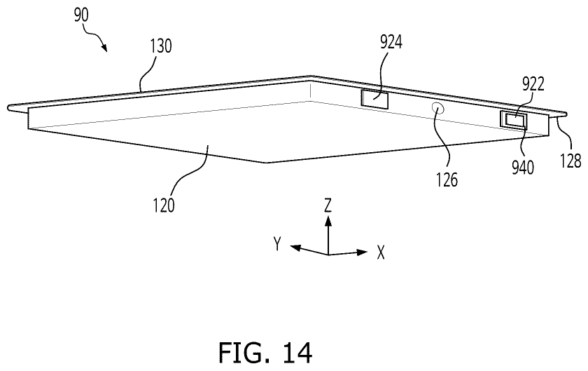

FIG. 14 is a perspective view of a secondary battery 90 according to some embodiments of the present disclosure. The secondary battery 90 may include the insulating member 900 described with reference to FIG. 9.

An insulating member 900 may be disposed between one surface of a case body 120, in which a first lead tab hole and a second lead tab hole are formed, and an electrode assembly. A first lead tab 922 may be exposed to outside of a case through the first lead tab hole. Additionally, an insulating portion 940 surrounding the first lead tab 922 may be exposed to the outside. Furthermore, a second lead tab 924 may be exposed to outside of the case through the second lead tab hole.

A first coupling portion of the insulating member 900 may be coupled with a first sub-region of the first lead tab hole, and a second coupling portion of the insulating member 900 may be coupled with a second sub-region of the second lead tab hole. Here, the first sub-region may be a partial region of the case body 120 surrounding the first lead tab hole, and the second sub-region may be a partial region of the case body 120 surrounding the second lead tab hole. As a result, the insulating member 900 may be fixed inside the secondary battery 90. In this arrangement, an electrolyte passage of the insulating member 900 may face an electrolyte injection port 126 of the case.

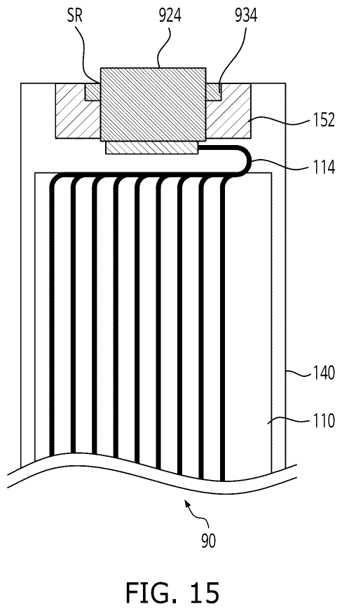

FIG. 15 is a cross-sectional view of a secondary battery 90 according to some embodiments of the present disclosure. In FIG. 14, a cut line C that crosses the center of a second lead tab 924 in a thickness direction of the secondary battery 90 (such as, for example, a Z-axis direction in FIG. 14) is shown. In FIG. 15, the structure of the secondary battery 90 will be described with reference to a cross-sectional view of the secondary battery 90 taken approximately along the cut line C.

A body portion 152 of an insulating member may be disposed between an electrode assembly 110 and one surface of a case 140. A second coupling portion 934 surrounding at least a portion of a side surface of a second lead tab 924 may be coupled with a second sub-region SR. The second coupling portion 934 and the second sub-region SR may be coupled by welding outside the case 140.

At least a portion of a lower surface of the second lead tab 924 may be electrically connected to a second electrode tab 114. After the second electrode tab 114 and the lower surface of the second lead tab 924 are coupled by welding or the like, the second electrode tab 114 may be bent under an insulating member. Referring to FIG. 15, the second electrode tab 114 may comprise a plurality of base material tabs. But the present disclosure is not limited thereto and may comprise a single base material tab.

An insulating member according to embodiments of the present disclosure may simultaneously perform the role of a terminal that electrically connects an electrode tab of an electrode assembly 110 with an external device and the role of an insulating member that prevents a short circuit inside a secondary battery 90. As a result, there is no need to assemble a positive electrode terminal, a negative electrode terminal, etc. to a case 140. Consequently, the time and cost required for the manufacturing process of the secondary battery 90 may be reduced.

In addition, by using an insulating member according to embodiments of the present disclosure instead of a positive electrode terminal, a negative electrode terminal, and an insulating object for preventing a short circuit inside a secondary battery 90, the volume of the secondary battery 90 may be reduced. Accordingly, the energy density of the secondary battery 90 may be increased.

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE NUMERALS

100: secondary battery
110: electrode assembly
112: first electrode tab
114: second electrode tab
120: case body
122: first lead tab hole
124: second lead tab hole
126: electrolyte injection port
128: flange
130: cover
140: case
150: insulating member
152: body portion
154: first lead tab
156: second lead tab
158: electrolyte passage

What is claimed is:

1. An insulating member for a secondary battery, the insulating member being configured to be disposed in a gap between an electrode assembly and a case in which the electrode assembly is accommodated, the insulating member comprising:
a plate shaped body portion comprising an insulating material;
a first lead tab at least partially penetrating the body portion and configured to be electrically connected to a first electrode tab of the electrode assembly; and
a second lead tab at least partially penetrating the body portion and configured to be electrically connected to a second electrode tab of the electrode assembly.

2. The insulating member for a secondary battery as claimed in claim 1, further comprising an electrolyte passage penetrating the body portion and configured to allow an electrolyte to be supplied to the electrode assembly.

3. The insulating member for a secondary battery as claimed in claim 1, wherein at least a portion of the first lead tab is configured to penetrate the case and protrude from one a surface of the case, and
wherein at least a portion of the second lead tab is configured to penetrate the case and protrude from the surface of the case.

4. The insulating member for a secondary battery as claimed in claim 1, wherein at least a portion of a surface of the first lead tab configured to face the electrode assembly is configured to be coupled to the first electrode tab, and
wherein at least a portion of a surface of the second lead tab configured to face the electrode assembly is configured to be coupled to the second electrode tab.

5. The insulating member for a secondary battery as claimed in claim 4, wherein the surface of the first lead tab comprises a first coupling region configured to be coupled with the first electrode tab,
wherein the surface of the second lead tab comprises a second coupling region configured to be coupled with the second electrode tab,
wherein a periphery of the first coupling region is spaced apart from an outer periphery of the surface of the first lead tab by a predetermined distance, and
wherein a periphery of the second coupling region is spaced apart from an outer periphery of the surface of the second lead tab by a predetermined distance.

6. The insulating member for a secondary battery as claimed in claim 4, wherein the surface of the first lead tab protrudes from the body portion, and
wherein the surface of the second lead tab protrudes from the body portion.

7. The insulating member for a secondary battery as claimed in claim 6, wherein surface of the body portion is configured to face the electrode assembly,
wherein a distance between the surface of the first lead tab and the surface of the body portion is less than or equal to 1 mm, and
wherein a distance between the surface of the second lead tab and the surface of the body portion is less than or equal to 1 mm.

8. The insulating member for a secondary battery as claimed in claim 4, wherein the surface of the first lead tab is recessed into the body portion, and
wherein one surface of the second lead tab is recessed into the body portion.

9. The insulating member for a secondary battery as claimed in claim 8, wherein surface of the body portion is configured to face the electrode assembly,
wherein a distance between the surface of the first lead tab and the surface of the body portion is less than or equal to 1 mm, and
wherein a distance between the surface of the second lead tab and the surface of the body portion is less than or equal to 1 mm.

10. The insulating member for a secondary battery as claimed in claim 1, further comprising an insulating portion surrounding at least a portion of a side surface of the first lead tab.

11. The insulating member for a secondary battery as claimed in claim 10, wherein a distance between an inner periphery and an outer periphery of the insulating portion is greater than or equal to 0.5 mm.

12. The insulating member for a secondary battery as claimed in claim 10, further comprising a coupling portion surrounding at least a portion of a side surface of the insulating portion and configured to be coupled with the case.

13. The insulating member for a secondary battery as claimed in claim 12, wherein a distance between an inner periphery and an outer periphery of the coupling portion is greater than or equal to 1.0 mm.

14. The insulating member for a secondary battery as claimed in claim 1, further comprising a coupling portion surrounding at least a portion of a side surface of the second lead tab and configured to be coupled with the case.

15. The insulating member for a secondary battery as claimed in claim 14, wherein a distance between an inner periphery and an outer periphery of the coupling portion is greater than or equal to 1.0 mm.

16. A secondary battery comprising:
a case;
an electrode assembly accommodated in the case; and
an insulating member disposed in a gap between the electrode assembly and the case,
wherein the insulating member comprises:
a body portion having a plate shape and comprising an insulating material;
a first lead tab at least partially penetrating the body portion and configured to be electrically connected to a first electrode tab of the electrode assembly; and
a second lead tab at least partially penetrating the body portion and configured to be electrically connected to a second electrode tab of the electrode assembly.

17. The secondary battery as claimed in claim 16, wherein the case comprises a first lead tab hole penetrating one surface of the case and a second lead tab hole penetrating the one surface of the case,
wherein the insulating member is disposed between the one surface of the case and the electrode assembly,
wherein the first lead tab is inserted into the first lead tab hole, and
wherein the second lead tab is inserted into the second lead tab hole.

18. The secondary battery as claimed in claim 17, wherein the insulating member comprises:
an insulating portion disposed to surround at least a portion of a side surface of the first lead tab;
a first coupling portion disposed to surround at least a portion of a side surface of the insulating portion and configured to be coupled with the case; and
a second coupling portion disposed to surround at least a portion of a side surface of the second lead tab and configured to be coupled with the case,
wherein a first sub-region of the case surrounding the first lead tab hole is coupled with the first coupling portion, and
wherein a second sub-region of the case surrounding the second lead tab hole is coupled with the second coupling portion.

19. The secondary battery as claimed in claim 16, wherein the insulating member further comprises an electrolyte passage formed to penetrate the body portion and configured to supply an electrolyte to the electrode assembly,
wherein the case comprises an electrolyte injection port formed on one surface of the case to allow an electrolyte to be injected, and
wherein the electrolyte injection port faces the electrolyte passage.

20. The secondary battery as claimed in claim 16, wherein the first electrode tab and the second electrode tab are bent between the insulating member and the electrode assembly.
